(19) United States
(12) Patent Application Publication
(10) Pub. No.: US 2017/0142379 A1
(43) Pub. Date: May 18, 2017

(54) IMAGE PROJECTION SYSTEM, PROJECTOR, AND CONTROL METHOD FOR IMAGE PROJECTION SYSTEM

(71) Applicant: Seiko Epson Corporation, Tokyo (JP)

(72) Inventor: Hirohiko Kihara, Matsumoto-shi (JP)

(21) Appl. No.: 15/351,270

(22) Filed: Nov. 14, 2016

(30) Foreign Application Priority Data
Nov. 13, 2015 (JP) 2015-222769

(51) Int. Cl. H04N 9/31; G06F 3/14

(52) U.S. Cl. CPC H04N 9/3179; H04N 9/3194; G06F 3/1423

(57) ABSTRACT

An image projection system includes a projector and a terminal device. The projector includes a projecting section configured to project an image and a generating section configured to generate a correspondence image indicating correspondence between a projected image projected by the projecting section and a region where the projected image is movable. The terminal device includes a display section including a display screen, an operation section configured to receive operation on the display screen, and a control section configured to cause the display screen to display the correspondence image transmitted by the projector and transmit, during the display of the correspondence image, operation data indicating operation received by the operation section to the projector. The projector includes a control section configured to control the projecting section according to the operation indicated by the operation data and move a projecting position of the projected image.

The entire disclosure of Japanese Patent Application No. 2015-222769, filed Nov. 13, 2015 is expressly incorporated by reference herein.

### BACKGROUND

1. Technical Field

The present invention relates to an image projection system, a projector, and a control method for the image projection system.

2. Related Art

There has been known a technique for photographing a projected image projected by a projector and operating a state of the projected image (see, for example, JP-A-2013-192098 (Patent Literature 1)). Patent Literature 1 discloses a projection system including a projecting device that projects an image including a marker on a projection surface and a terminal device that generates correction information for correcting a marker position on the basis of a photographed image obtained by photographing the projection surface and transmits the correction information to the projecting device.

However, in the configuration disclosed in Patent Literature 1, it is necessary to retain the terminal device in a state in which the projection surface can be appropriately photographed. Therefore, it is complicated for a user to photograph the projection surface using the terminal device.

### SUMMARY

An advantage of some aspects of the invention is to improve operability in operating, with a terminal device, a state of a projected image projected by a projector.

An image projection system according to an aspect of the invention includes: a projector; and a terminal device. The projector includes: a projecting section configured to project an image; a generating section configured to generate a correspondence image indicating correspondence between a projected image projected by the projecting section and a region where the projected image is movable; and a transmitting section configured to transmit the correspondence image generated by the generating section to the terminal device. The terminal device includes: a display section including a display screen; an operation section configured to receive operation on the display screen; and a control section configured to cause the display screen to display the correspondence image transmitted by the projector and transmit, during the display of the correspondence image, operation data indicating operation received by the operation section to the projector. The projector includes a control section configured to control the projecting section according to the operation indicated by the operation data and move a projecting position of the projected image.

According to the configuration of the aspect of the invention, the correspondence image indicating the correspondence between the projected image and the region where the projected image is movable, which is transmitted from the projector, is displayed on the display screen of the terminal device. Therefore, a user can perform operation in the terminal device while viewing the correspondence image transmitted from the projector. Consequently, it is possible to improve operability in operating, with the terminal device, a state of the projected image projected by the projector.

In the image projection system according to the aspect of the invention, the projector may include a photographing section configured to photograph the projected image, and the generating section may generate the correspondence image on the basis of a photographed image of the photographing section.

According to the configuration, the correspondence image is generated on the basis of the photographed image photographed by the photographing section of the projector. The photographing section of the projector photographs the projected image from a fixed position. Therefore, it is possible to cause the terminal device to display an image in which the correspondence between the projected image and the region where the projected image is movable is indicated by a photographed image photographed from the fixed position.

In the image projection system according to the aspect of the invention, the projecting section may includes: a projection lens; and a lens shift mechanism configured to shift the projection lens and move the projecting position of the projected image, and the generating section may generate the correspondence image indicating a region where the lens shift mechanism can move the projected image by shifting the projection lens.

According to the configuration, it is possible to display, in the correspondence image, the region where the projection lens is movable by the lens shift mechanism.

In the image projection system according to the aspect of the invention, the projecting section may project an image on a projection target, and the generating section may generate the correspondence image including the projected image, the region where the projected image is movable, and figure data indicating a positional relation between the projected image and the region where the projected image is movable, an extracted image obtained by extracting a portion corresponding to the projected image from the photographed image being combined with the figure data.

According to the configuration, it is possible to generate the projected image, the region where the projected image is movable, and the correspondence image indicating the positional relation between the projected image and the region where the projected image is movable. Therefore, it is possible to recognize, from the correspondence image displayed on the terminal device, the positional relation between the projected image and the region where the projected image is movable.

Since the portion corresponding to the projected image is extracted from the photographed image obtained by photographing the projected image and is combined with the correspondence image, it is possible to clearly indicate, in the correspondence image, the portion corresponding to the projected image.

A projector according to another aspect of the invention includes: a projecting section configured to project an image; a generating section configured to generate a correspondence image indicating correspondence between a projected image projected by the projecting section and a region where the projected image is movable; a transmitting section configured to transmit the correspondence image generated by the generating section to a terminal device; and a control section configured to control the projecting section according to operation indicated by operation data transmitted by the terminal device to move a projecting position of the projected image.

According to the configuration the aspect of the invention, the correspondence image indicating the correspondence between the projected image and the region where the projected image is movable is displayed on a display screen of the terminal device. The projecting position of the projected image is moved according to the operation indicated by the data transmitted from the terminal device. Therefore, it is possible to cause the terminal device to display information for supporting operation in the terminal device and improve operability in the terminal device.

A control method for an image projection system according to still another aspect of the invention is a control method for an image projection system including a projector and a terminal device. The control method includes: the projector generating a correspondence image indicating correspondence between a projected image projected by a projecting section that projects an image and a region where the projected image is movable; the projector transmitting the generated correspondence image to the terminal device; the terminal device causing a display screen to display the correspondence image transmitted by the projector; the terminal device receiving, in an operation section, operation on the display screen during the display of the correspondence image; the terminal device transmitting operation data indicating the received operation to the projector; and the projector moving a projecting position of the projected image according to the operation indicated by the operation data.

According to the configuration of the aspect of the invention, the correspondence image indicating the correspondence between the projected image and the region where the projected image is movable, which is transmitted from the projector, is displayed on the display screen of the terminal device. Therefore, a user can perform operation in the terminal device while viewing the correspondence image transmitted from the projector. Consequently, it is possible to improve operability in operating, with the terminal device, a state of the projected image projected by the projector.

### BRIEF DESCRIPTION OF THE DRAWINGS

The invention will be described with reference to the accompanying drawings, wherein like numbers reference like elements.

FIG. 1 is a diagram showing the schematic configuration of an image projection system.

FIGS. 2A and 2B are block diagrams showing the configurations of a projector and a terminal device.

FIG. 3 is a flowchart for explaining the operations of the projector and the terminal device.

FIG. 4 is a flowchart for explaining the operations of the projector and the terminal device.

FIG. 5 is a flowchart for showing the operation of the projector and the terminal device.

FIG. 6 is a flowchart for showing the operation of the projector and the terminal device.

FIG. 7 is a diagram showing positional relation image data.

FIG. 8 is a diagram showing a combined image displayed on a display panel of the terminal device.

### DESCRIPTION OF EXEMPLARY EMBODIMENTS

An embodiment of the invention is explained below with reference to the drawings.

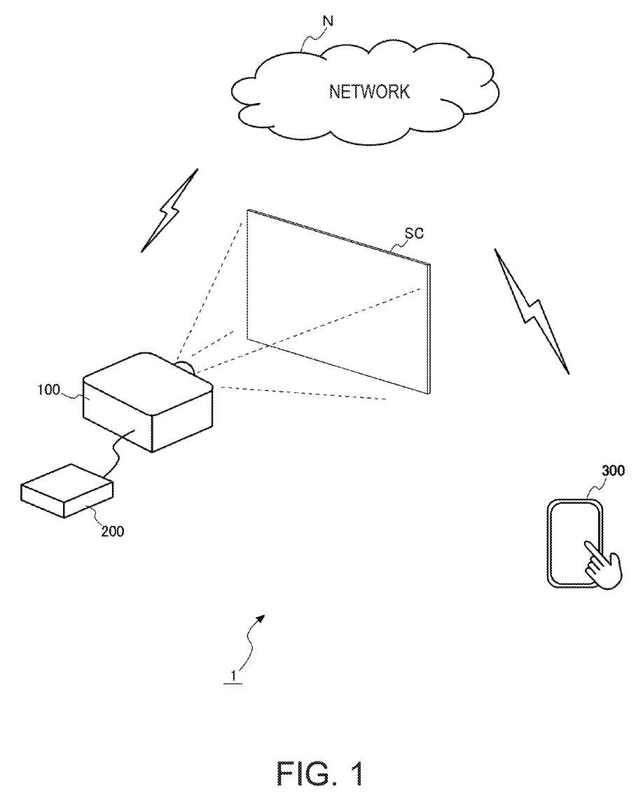

FIG. 1 is a diagram showing the schematic configuration of an image projection system 1. The image projection system 1 includes a projector 100 and a terminal device 300. The projector 100 and the terminal device 300 are connected to be capable of performing data communication with each other via a network N such as the Internet.

The projector 100 may be set on a floor in front of a screen SC serving as a projection target or may be suspended from a ceiling. When the projector 100 is set on the floor, the projector 100 may be set on a stand set on the floor. A target on which the projector 100 projects an image may be a flat projection surface such as the screen SC or a wall surface of a building or may be an object not uniformly flat such as a building or a material body. In this embodiment, as an example, an image is projected on the screen SC.

The terminal device 300 is a communication device usable by being carried such as a smartphone, a cellular phone, a tablet PC (Personal Computer), or a PDA (Personal Digital Assistant). In this embodiment, as an example, the terminal device 300 is a smartphone. The terminal device 300 performs wireless communication with the projector 100 and, for example, instructs the projector 100 to change a display position on the screen SC of an image projected by the projector 100.

The projector 100 is, for example, connected to the network N via a wireless router (not shown in the figure). The network N is a communication network configured by a public line network, a leased line, or the like. The network N may be an open network such as the Internet or may be a closed network accessible by a specific device. The wireless router relays data communication between the projector 100 and the terminal device 300.

The terminal device 300 is connected to, via a mobile communication line, for example, a base station (not shown in the figure) connected to the network N. The base station relays the data communication between the projector 100 and the terminal device 300.

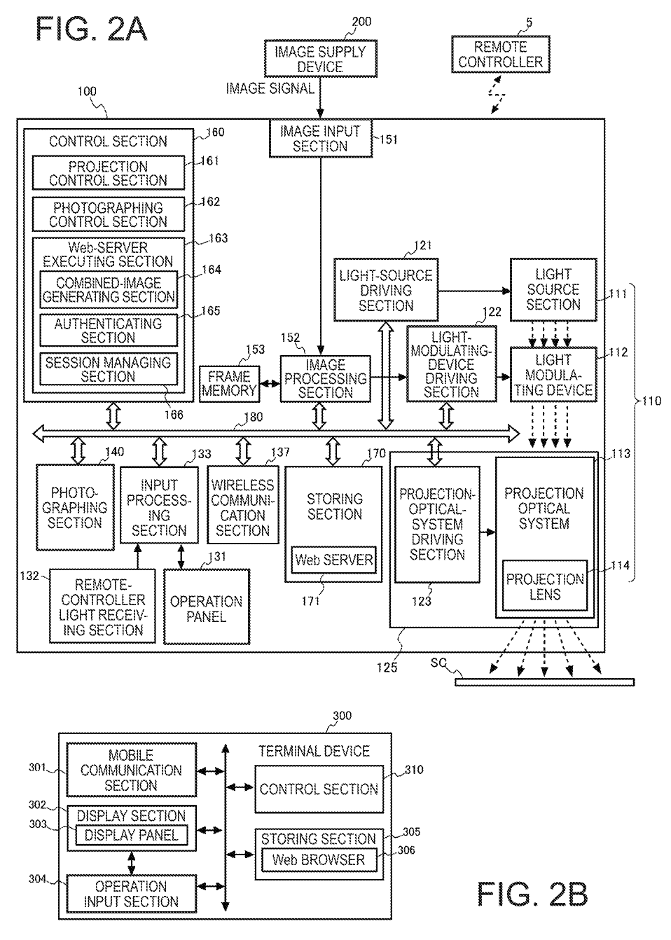

FIGS. 2A and 2B are block diagrams showing the configurations of the projector 100 and the terminal device 300. FIG. 2A shows the configuration of the projector 100. FIG. 2B shows the configuration of the terminal device 300.

First, the configuration of the projector 100 is explained. An image supply device 200 is connected to the projector 100. The image supply device 200 is a device that supplies an image signal to the projector 100. The projector 100 projects, on the screen SC, an image based on an image signal supplied from the image supply device 200 or image data stored in advance in a storing section 170 explained below. As the image supply device 200, for example, a video output device such as a video player, a DVD (Digital Versatile Disk) player, a television tuner device, a set-top box of a CATV (Cable television), or a video game device or a personal computer is used.

The projector 100 includes an image input section 151. The image input section 151 includes a connector, to which a cable is connected, and an interface circuit (both of which are not shown in the figure). An image signal supplied from the image supply device 200 connected via the cable is input to the image input section 151. The image input section 151 converts the input image signal into image data and outputs the image data to an image processing section 152.

The interface included in the image input section 151 maybe an interface for data communication such as Ethernet (registered trademark), IEEE 1394, or USB. The interface of the image input section 151 may be an interface for image data such as MHL (registered trademark), HDMI (registered trademark), or DisplayPort.

The image input section 151 may include, as the connector, a VGA terminal to which an analog video signal is input or a DVI (Digital Visual Interface) terminal to which digital video data is input. Further, the image input section 151 includes an A/D conversion circuit. When an analog video signal is input via the VGA terminal, the image input section 151 converts, with the A/D conversion circuit, the analog video signal into image data and outputs the image data to the image processing section 152.

The projector 100 includes a display section 110 that performs formation of an optical image and projects (displays) the image on the screen SC. The display section 110 includes a light source section 111 functioning as a light source, a light modulating device 112, and a projection optical system 113.

The light source section 111 includes a light source such as a Xenon lamp, an ultra-high pressure mercury lamp, an LED (Light Emitting Diode), or a laser light source. The light source section 111 may include a reflector and an auxiliary reflector that lead light emitted by the light source to the light modulating device 112. Further, the light source section 111 may include a lens group for improving an optical characteristic of projected light, a sheet polarizer, and a dimming element that reduces a light amount of the light emitted by the light source on a route leading to the light modulating device 112 (all of which are not shown in the figure).

The light source section 111 is driven by a light-source driving section 121. The light-source driving section 121 is connected to an internal bus 180. The light-source driving section 121 lights and extinguishes the light source of the light source section 111 according to control by a control section 160.

The light modulating device 112 includes, for example, three liquid crystal panels corresponding to the three primary colors of RGB. Light emitted by the light source section 111 is separated into color lights of the three colors of RGB and made incident on the liquid crystal panels corresponding to the color lights. The three liquid crystal panels are transmissive liquid crystal panels. The liquid crystal panels modulate transmitted lights and generate image lights. The image lights passed through the liquid crystal panels and modulated are combined by a combination optical system such as a cross dichroic prism and emitted to the projection optical system 113.

A light-modulating-device driving section 122 that drives the liquid crystal panels of the light modulating device 112 is connected to the light modulating device 112. The light-modulating-device driving section 122 is connected to the internal bus 180.

The light-modulating-device driving section 122 generates image signals of R, G, and B respectively on the basis of display image data (explained below) input from the image processing section 152. The light-modulating-device driving section 122 drives, on the basis of the generated image signals of R, G, and B, the liquid crystal panels of the light modulating device 112 corresponding to the image signals and draws images on the liquid crystal panels.

The projection optical system 113 includes a projection lens 114 that enlarges and projects the image lights modulated by the light modulating device 112. The projection lens 114 is a zoom lens that projects the image lights modulated by the light modulating device 112 on the screen SC at desired magnification.

A projection-optical-system driving section (a lens shift mechanism) 123 is connected to the projection optical system 113. The projection optical system 113 and the projection-optical-system driving section 123 configure a projecting section 125. The projection-optical-system driving section 123 is connected to the internal bus 180. The projection-optical-system driving section 123 performs, according the control of the control section 160, lens shift adjustment for moving the projection lens 114 within a plane orthogonal to the optical axis of the projection lens 114 and moving an image projected on the screen SC in upward, downward, left, and right directions.

The projector 100 includes an operation panel 131 and an input processing section 133. The input processing section 133 is connected to the internal bus 180.

Various operation keys and a display screen configured by a liquid crystal panel are displayed on the operation panel 131 functioning as a user interface. When the operation key displayed on the operation panel 131 is operated, the input processing section 133 outputs data corresponding to the operated key to the control section 160. The input processing section 133 causes, according to the control of the control section 160, the operation panel 131 to display various screens.

A touch sensor that detects a touch on the operation panel 131 is superimposed on and integrally formed with the operation panel 131. The input processing section 133 detects a position of the operation panel 131 touched by, for example, a finger of a user as an input position and outputs data corresponding to the detected input position to the control section 160.

The projector 100 includes a remote-controller light receiving section 132 that receives an infrared signal transmitted from a remote controller 5 used by the user. The remote-controller light receiving section 132 is connected to the input processing section 133.

The remote-controller light receiving section 132 receives an infrared signal transmitted from the remote controller 5. The input processing section 133 decodes the infrared signal received by the remote-controller light receiving section 132, generates data indicating operation content in the remote controller 5, and outputs the data to the control section 160.

The projector 100 includes a wireless communication section (a transmitting section) 137. The wireless communication section 137 includes an antenna and an RF (Radio Frequency) circuit (both of which are not shown in the figure) and performs communication with a wireless router through a wireless LAN (Local Area Network). Data transmitted from the projector 100 is transmitted to the terminal device 300 via the wireless LAN, the network N, and the mobile communication line. A wireless communication system of the wireless communication section 137 is not limited to the wireless LAN. A short range wireless communication system such as Bluetooth (registered trademark), UWB, and infrared communication or a wireless communication system that makes use of the mobile communication line can be adopted.

The projector 100 includes a photographing section 140.

The photographing section 140 includes an image pickup optical system, an image pickup element, and an interface circuit. The photographing section 140 photographs a projecting direction of the projection optical system 113 according to the control by the control section 160.

A photographing range, that is, an angle of view of the photographing section 140 is an angle of view for setting, as a photographing range, a range including the screen SC and a peripheral section of the screen SC. The photographing section 140 outputs photographed image data to the control section 160.

The projector 100 includes an image processing system. The image processing system is configured centering on the control section 160 that collectively controls the entire projector 100. Besides, the projector 100 includes the image processing section 152, a frame memory 153, and the storing section 170. The control section 160, the image processing section 152, and the storing section 170 are connected to the internal bus 180.

The image processing section 152 develops, according to the control by the control section 160, in the frame memory 153, the image data input from the image input section 151. The image processing section 152 performs, on the image data developed in the frame memory 153, processing such as resolution conversion (scaling) processing, resize processing, correction of distortion aberration, shape correction processing, digital zoom processing, and adjustment of a tone and brightness of an image. The image processing section 152 executes processing designated by the control section 160 and performs, according to necessity, the processing using parameters input from the control section 160. Naturally, the image processing section 152 can also execute a plurality of kinds of processing among the kinds of processing in combination.

The image processing section 152 reads out the image data after the processing from the frame memory 153 and outputs the image data to the light-modulating-device driving section 122 as display image data.

The control section 160 includes hardware such as a CPU, a ROM, and a RAM (all of which are not shown in the figure). The ROM is a nonvolatile storage device such as a flash ROM and stores control programs and data. The RAM configures a work area of the CPU. The CPU develops the control programs read out from the ROM or the storing section 170 in the RAM and executes the control programs developed in the RAM to control the sections of the projector 100.

The control section 160 includes, as functional blocks, a projection control section 161, a photographing control section 162, and a Web-server executing section 163. The Web-server executing section 163 is a functional section realized by executing a Web server 171 stored in the storing section 170. The Web-server executing section 163 includes a combined-image generating section (a generating section) 164, an authenticating section 165, and a session managing section 166. These functional blocks are realized by the CPU executing the control programs stored in the ROM or the storing section 170.

The projection control section 161 controls the projection-optical-system driving section 123, adjusts a display form of an image in the display section 110, and executes projection of the image on the screen SC.

Specifically, the projection control section 161 controls the image processing section 152 to carry out image processing on image data input from the image input section 151. In this case, the projection control section 161 may read out, from the storing section 170, parameters necessary for the processing by the image processing section 152 and output the parameters to the image processing section 152.

The projection control section 161 controls the light-source driving section 121 to light the light source of the light source section 111 and adjust the luminance of the light source. Consequently, the light source emits light. Image lights modulated by the light modulating device 112 are projected on the screen SC by the projection optical system 113. The projection control section 161 controls the projection-optical-system driving section 123 on the basis of lens movement amount parameters. The projection control section 161 manages a lens position of the projection lens 114 according to the lens movement amount parameters. The lens movement amount parameters include a vertical movement amount parameter indicating a movement amount in the vertical direction of the projection lens 114 and a horizontal movement amount parameter indicating a movement amount in the horizontal direction of the projection lens 114.

The photographing control section 162 causes the photographing section 140 to execute photographing and acquires photographed image data photographed by the photographing section 140.

The Web-server executing section 163 executes the Web server 171 stored in the storing section 170 and exchanges data such as HTML data forming a Web page through the network N in response to a request from client software such as a Web browser 306 (see FIG. 2B).

The combined-image generating section 164 generates a combined image. Details of the combined image are explained below. The combined image is an image displayed on a display panel (a display screen) 303 of the terminal device 300 when the projector 100 performs the lens shift adjustment according to operation of the terminal device 300.

The authenticating section 165 authenticates a user requesting to log in. The session managing section 166 manages session information of the user successful in the authentication in the authenticating section 165.

The storing section 170 is a nonvolatile storage device and is realized by a storage device such as a flash memory, an EPROM (Erasable Programmable ROM), an EEPROM (Electrically EPROM), or a HDD (Hard Disc Drive). The storing section 170 stores the Web server 171, which is a control program having a function of data transmission reception in the Worldwide Web (WWW). The storing section 170 stores, as authentication information for authenticating registered users, user IDs and passwords of the users. Further, the storing section 170 stores an IP address set in the projector 100 and pattern image data (explained below), which is image data projected on the screen SC by the display section 110.

The configuration of the terminal device 300 is explained.

The terminal device 300 includes a mobile communication section 301, a display section 302, an operation input section (an operation section) 304, a storing section 305, and a control section 310.

The mobile communication section 301 is connected to a mobile communication line such as an LTE (Long Term Evolution) line or a 3G line and performs wireless communication between the terminal device 300 and a base station. The mobile communication line is a line through which not only voice call but also data communication is possible. Data transmitted from the terminal device 300 is sent to the projector 100 via the mobile communication line, the network N, and the wireless LAN.

The display section 302 includes the display panel (the display screen) 303 such as a liquid crystal display. The display section 302 causes the display panel 303 to display an image according to control by the control section 310. The display panel 303 is not limited to the liquid crystal display and may be an organic EL (electro-luminescence) display.

The operation input section 304 includes a touch sensor that detects a touch on the display panel 303 by a finger or a touch pen. A type of the touch sensor may be any type such as a capacitance type, an ultrasound type, a pressure sensitive type, a resistive film type, or an optical detection type. The touch sensor is configured integrally with the display panel 303. The operation input section 304 specifies a position of the display panel 303 that touched by a pointer and outputs data (coordinate data) indicating the specified position to the control section 310.

The operation input section 304 includes a plurality of push button keys disposed around the display section 302. The operation input section 304 receives pressing operation of the push button key and outputs data indicating operation set in the pressed push button key to the control section 310.

The storing section 305 stores an OS (Operating System) executed by a CPU of the control section 310 and application programs such as the Web browser 306 for general-purpose use. The storing section 305 stores, in a nonvolatile manner, data to be processed by the control section 310.

The control section 310 includes the CPU, a ROM, and a RAM as hardware. The CPU develops control programs stored in the ROM or the storing section 305 in the RAM and executes the developed control programs to control the sections of the terminal device 300. The control section 310 executes the Web browser 306 stored by the storing section 305 and exchanges data such as HTML data forming a Web page between the terminal device 300 and the projector 100 functioning as a server.

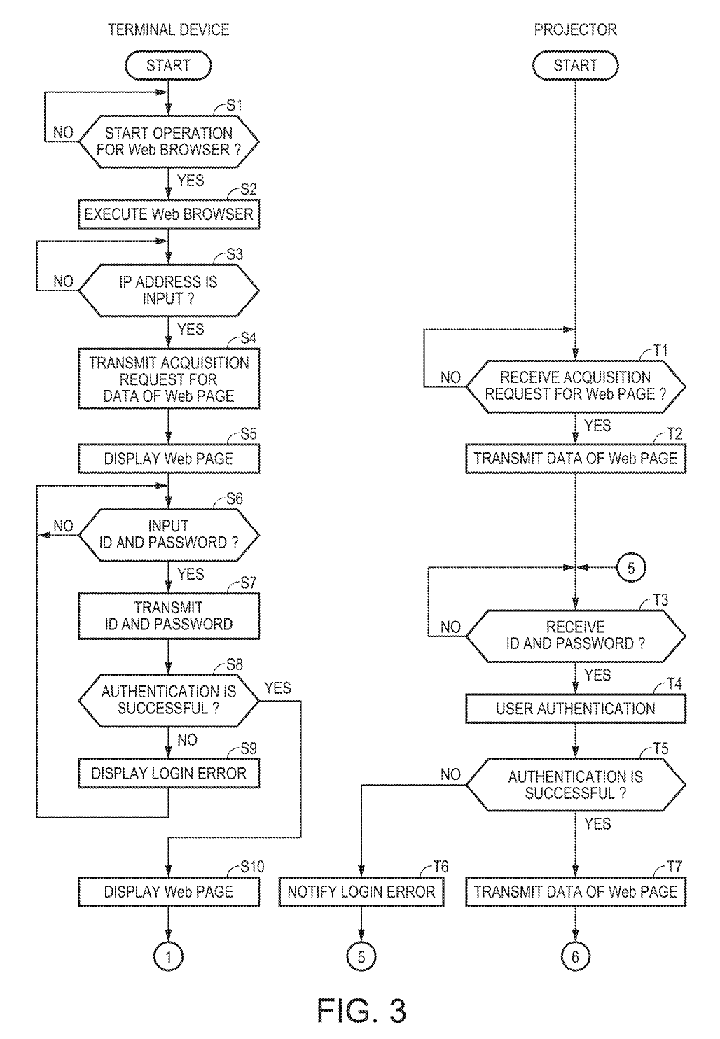

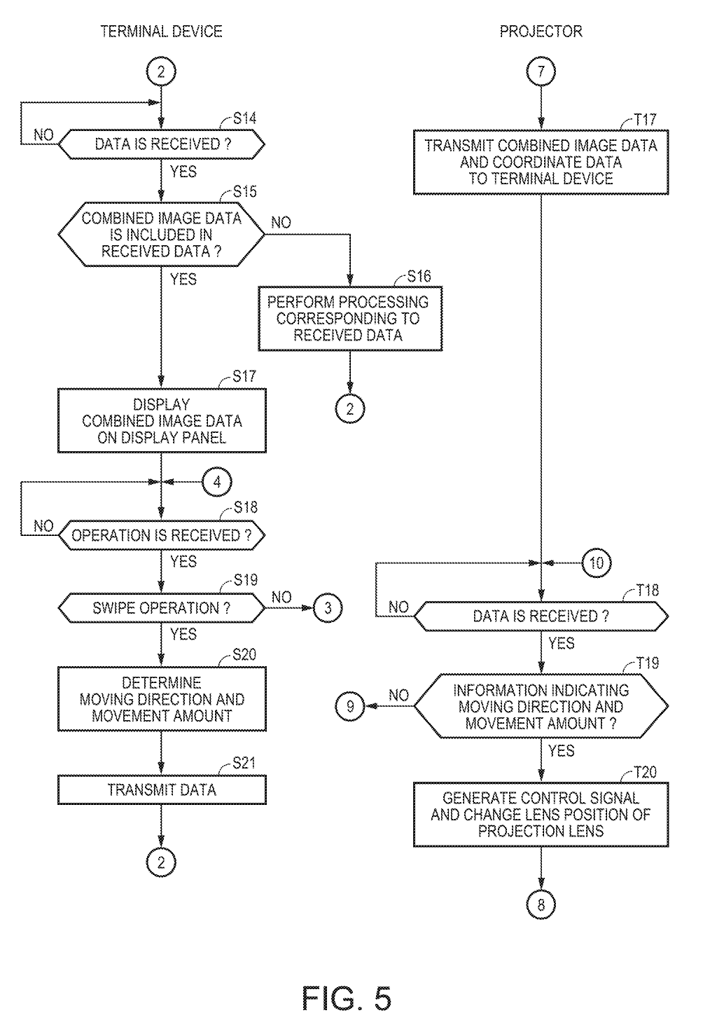

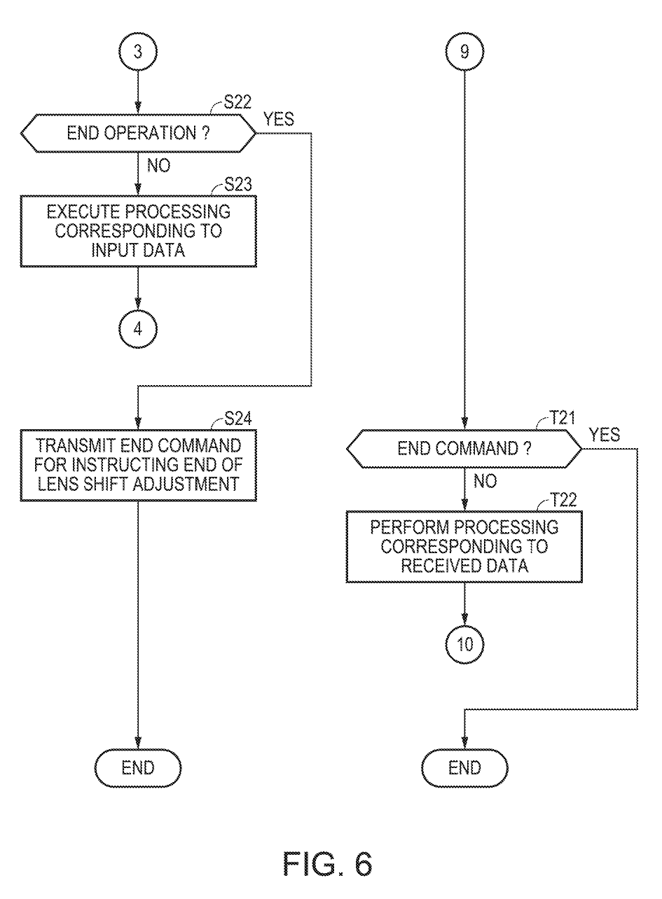

FIGS. 3 to 6 are flowcharts for explaining the operations of the projector 100 and the terminal device 300.

The user operates the terminal device 300 to start the Web browser 306. The operation of the terminal device 300 for starting the Web browser 306 includes operation of the push button key or touch operation on the display panel 303. The control section 310 of the terminal device 300 stays on standby until the control section 310 receives the operation for starting the Web browser 306 (NO in step S1). When receiving the operation for starting the Web browser 306 (YES in step S1), the control section 310 executes the Web browser 306 (step S2).

Subsequently, the user inputs the IP address of the projector 100 on a display screen of the Web browser 306 displayed on the display panel 303. When receiving a display request for the IP address from the operation panel 131 or the remote controller 5, the control section 160 of the projector 100 may cause the operation panel 131 to display the IP address set in the projector 100. The control section 160 may cause the screen SC to display a two-dimensional code such as a QR code (registered trademark) having, as connection information to the projector 100, the IP address of the projector 100 or a URL corresponding to the IP address. The user photographs the two-dimensional code with a camera (not shown in the figure) mounted on the terminal device 300. The control section 310 of the terminal device 300 analyzes the two-dimensional code from photographed image data of the camera, extracts the connection information, and connects the terminal device 300 to the projector 100.

Subsequently, the control section 310 of the terminal device 300 determines whether the IP address is input to an address bar of the display screen displayed by the Web browser 306 (step S3). When the IP address is not input (NO in step S3), the control section 310 stays on standby until the IP address is input. When receiving the IP address (YES in step S3), the control section 310 transmits an acquisition request for data of a Web page to the projector 100 (the Web server 171) specified by the received IP address (step S4).

The Web-server executing section 163 of the projector 100 stays on standby until the acquisition request for data of a Web page is received via the network N (NO in step T1).

When receiving the acquisition request for data of a Web page (YES in step T1), the Web-server executing section 163 of the projector 100 transmits data of a Web page, to which an ID and a password can be input, to the terminal device 300 that receives the acquisition request for data of a Web page (step T2).

The terminal device 300 receives, with the mobile communication section 301, the data of the Web page transmitted from the projector 100 via the network N. The control section 310 causes the display panel 303 to display the data of the Web page received by the mobile communication section 301 (step S5).

In the Web page displayed on the display panel 303, input fields of an ID and a password are displayed. The user inputs, with operation of the push button keys or touch operation, an ID and a password to the input fields displayed on the Web page. The control section 310 determines whether the ID and the password are input by the operation of the push button keys or the touch operation (step S6). When the ID and the password are not input (NO in step S6), the control section 310 stays on standby until the ID and the password are input. When receiving the ID and the password (YES in step S6), the control section 310 transmits the received ID and the received password to the projector 100 (step S7).

The Web-server executing section 163 of the projector 100 stays on standby until the Web-server executing section 163 receives the ID and the password transmitted from the terminal device 300 (NO in step T3). When receiving the ID and the password transmitted from the terminal device 300 (YES in step T3), the Web-server executing section 163 determines whether the received ID and the received password coincide with the ID and the password stored in the storing section 170 and performs user authentication (step T4). When the received ID and the received password do no coincide with the ID and the password stored in the storing section 170, the Web-server executing section 163 determines that the user authentication is unsuccessful (NO in step T5). In this case, the Web-server executing section 163 notifies the terminal device 300 of a login error (step T6) and requests the user to input an ID and a password again.

When receiving the notification of the login error from the projector 100, the control section 310 of the terminal device 300 determines that the user authentication is unsuccessful (NO in step S8) and causes the display panel 303 to display a login error (step S9). Thereafter, the Web-server executing section 163 of the projector 100 stays on standby until a new ID and a new password are transmitted from the terminal device 300 (step T3). When receiving the new ID and the new password (YES in step T3), the Web-server executing section 163 performs the user authentication again (step T4). When the user authentication is unsuccessful (NO in step T5), the Web-server executing section 163 notifies the terminal device 300 of a login error (step T6). However, when the user authentication is unsuccessful the number of times set in advance, the Web-server executing section 163 may perform processing to stop the user authentication and disable the user to log in for a fixed period.

When the received ID and the received password and the ID and the password stored in the storing section 170 coincide, the Web-server executing section 163 determines that the user authentication is successful (YES in step T5). In this case, the Web-server executing section 163 operates the terminal device 300 to transmit, to the terminal device 300, data of a Web page on which a list of functions capable of controlling the projector 100 is displayed (step T7). The control section 310 of the terminal device 300 determines that the authentication is successful (YES in step S8) and causes the display panel 303 to display a Web page (step S10). On the Web page, functions such as the lens shift adjustment, adjustment of a color and brightness of an image, and shape correction of an image projected on the screen SC are displayed.

The user selects, on the display panel 303 on which the Web page is displayed, the function of the lens shift adjustment with the touch operation or the operation of the push button key.

The control section 310 determines on the basis of data input from the operation input section 304 whether operation is received (step S11). When there is no input of data from the operation input section 304, the control section 310 determines that operation is not received (NO in step S11) and stays on standby until data is input. When data is input from the operation input section 304 and the control section 310 determines that operation is received (YES in step S11), the control section 310 generates an instruction command for instructing execution of a function selected by the received operation (step S12). The control section 310 controls the mobile communication section 301 to transmit the generated instruction command to the projector 100 through wireless communication (step S13).

The Web-server executing section 163 of the projector 100 determines whether the instruction command transmitted from the terminal device 300 is received by the wireless communication section 137 (step T8). When the instruction command is not received (NO in step T8), the Web-server executing section 163 stays on standby until the instruction command is received. When receiving the instruction command (YES instep T8), the Web-server executing section 163 determines whether the received instruction command is a command for instructing execution of the lens shift adjustment (step T9). When the received instruction command is not the command for instructing the execution of the lens shift adjustment (NO in step T9), the Web-server executing section 163 executes processing corresponding to the received instruction command (step T10) and returns to the determination in step T8.

When the received instruction command is a command for instructing the execution of the lens shift adjustment (YES in step T9), the control section 160 generates positional relation image data with the combined-image generating section 164 (step T11).

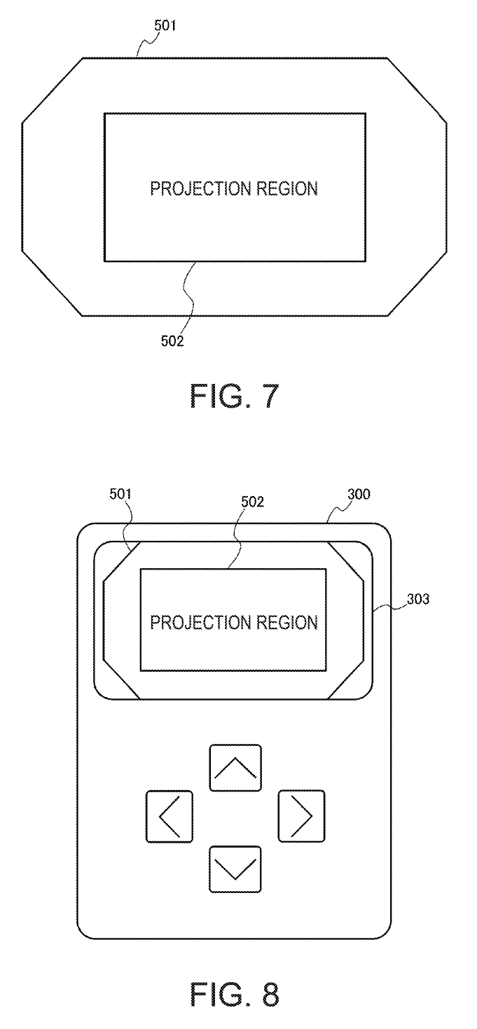

FIG. 7 is a diagram showing the positional relation image data.

The positional relation image data is image data indicating a positional relation between a lens shiftable region (a region where a projected image is movable) and a projection region. In the positional relation image data, figure data 501 indicating the lens shiftable region and figure data 502 indicating the size and the position of the projection region in the lens shiftable region are displayed.

The lens shiftable region indicates a range in which an image can be projected by moving the projection lens 114 within a plane orthogonal to the optical axis of the projection lens 114 through the lens shift adjustment. The projection region indicates a range of a projected image in the present lens position of the projection lens 114. In the following explanation, an image projected on the screen SC by the projector 100 is referred to as projected image.

When lens shift adjustment processing is started, first, the combined-image generating section 164 acquires the lens movement amount parameters (the vertical movement amount parameter and the horizontal movement amount parameter) and zoom magnification of the projection lens 114 from the projection control section 161.

The combined-image generating section 164 determines a relative relation between a projection region in the vertical direction and the lens shiftable region on the basis of the present value of the acquired vertical movement amount parameter and a range of a value that the vertical movement amount parameter can take. The combined-image generating section 164 determines a relative relation between a projection region in the horizontal direction and the lens shiftable region on the basis of the present value of the acquired horizontal movement amount parameter and a range of a value that the horizontal movement amount parameter can take. The combined-image generating section 164 determines a projection region of the projection lens 114 on the basis of the acquired zoom magnification. The combined-image generating section 164 generates positional relation image data on the basis of these kinds of determined information.

Subsequently, the combined-image generating section 164 reads out pattern image data from the storing section 170 and outputs the read-out pattern image data to the image processing section 152. In the pattern image data, for example, an image having a fixed color and a fixed pattern set in advance. When an image based on the pattern image data is projected on the screen SC and photographed by the photographing section 140, the pattern image data only has to be an image with which the image based on the pattern image data can be specified from photographed image data photographed by the photographing section 140. Note that, in the following explanation, the image based on the pattern image data is simply referred to as pattern image.

The image processing section 152 outputs the pattern image data input from the combined-image generating section 164 to the light-modulating-device driving section 122 as display image data. The light-modulating-device driving section 122 generates image signals of R, G, and B on the basis of the display image data and draws, on the liquid crystal panel of the light modulating device 112, an image (a pattern image) based on the generated image signals. The pattern image drawn on the liquid crystal panel of the light modulating device 112 is projected on the screen SC by the projection optical system 113 (step T12).

Subsequently, the photographing control section 162 controls the photographing section 140 to photograph a range including the screen SC and a portion around the screen SC and generates photographed image data (step T13). The photographing section 140 outputs the generated photographed image data to the control section 160.

The photographed image data sent from the photographing section 140 is input to the combined-image generating section 164. The combined-image generating section 164 specifies, from the input photographed image data, a range in which the pattern image is photographed (hereinafter referred to as pattern photographed image (extracted image)). The combined-image generating section 164 calculates a parameter of shape transformation for associating the specified pattern photographed image with the figure data 502 indicating a projection region of the positional relation image data (step T14).

For example, the combined-image generating section 164 compares the size in the longitudinal direction of the specified pattern photographed image and the size in the longitudinal direction of the figure data 502 indicating the projection region and calculates a parameter for transforming the pattern photographed image such that the size of the pattern photographed image coincides with the size of the figure data 502 indicating the projection region or the pattern photographed images fits in the figure data 502 indicating the projection region. Similarly, the combined-image generating section 164 compares the size in the lateral direction of the pattern photographed image and the size in the lateral direction of the figure data 502 indicating the projection region and calculates a parameter for transforming the pattern photographed image such that the size of the pattern photographed image coincides with the size of the figure data 502 indicating the projection region or the pattern photographed images fits in the figure data 502 indicating the projection region.

When the pattern photographed image specified from the photographed imaged data is not a rectangular image, the combined-image generating section 164 may calculate the parameter after correcting the shape of the pattern photographed image to be a rectangular shape.

Subsequently, the combined-image generating section 164 performs shape transformation of the photographed image data using the generated parameter in the vertical direction and the horizontal direction (step T15). The combined-image generating section 164 combines the shape-transformed photographed image data with the positional relation image data to generate combined image data (a corresponding image) (step T16). The combined-image generating section 164 combines, in the photographed image data, the pattern photographed image in the figure data 502 indicating the projection region of the positional relation image data. The combined-image generating section 164 combines the photographed image data other than the pattern photographed image on the outer side of the figure data 502 to generate combined image data.

Note that, when the size of the photographed image data is larger than the figure data 501 of the positional relation image data and the photographed image data lies off the figure data 501 to the outer side, the combined-image generating section 164 may delete the photographed image data in a laying-off portion.

Subsequently, the combined-image generating section 164 controls the wireless communication section 137 to transmit the generated combined image data and coordinate data indicating a range of the projection region in the combined image data to the terminal device 300 (step T17). The coordinate data is, for example, data indicating a coordinate in a coordinate system having the origin in the upper left of the combined image data.

The control section 310 of the terminal device 300 determines whether the data transmitted from the projector 100 is received by the mobile communication section 301 (step S14). When the data is not received (NO in step S14), the control section 310 stays on standby until the data is received (step S14). When the data is received (YES instep S14), the control section 310 determines whether the combined image data is included in the received data (step S15). When the combined image data is not included in the received data (NO in step S15), the control section 310 performs processing corresponding to the received data (step S16) and returns to the processing in step S14.

When the combined image data is included in the received data (YES instep S15), the control section 310 causes the display panel 303 to display the combined image data (step S17). The operation for causing the display panel 303 to display the combined image data (the corresponding image) includes operation in which the control section 310 of the terminal device 300 performs image processing such as resizing of the combined image data and causes the display panel 303 to display the combined image data after the resizing.

For example, when an aspect ratio of the received combined image data does not coincide with an aspect ratio of the display panel 303, the control section 310 resizes the combined image data and causes the display panel 303 to display the combined image data. In this case, the control section 310 maintains, in the combined image data after the resizing, the relative relation between the lens shiftable region and the projection region in the combined image data before the resizing on the basis of the coordinate data indicating the range of the projection region.

FIG. 8 is a diagram showing a combined image displayed on the display panel 303 of the terminal device 300.

In the combined image, the figure data 501 indicating the lens shiftable region and the figure data 502 indicating the projection region are displayed. The pattern photographed image is displayed on the inside of the figure data 502 indicating the projection region. The photographed image data other than the pattern photographed image data is displayed between the figure data 501 and the figure data 502.

The user instructs, with swipe operation, a change of the position of the projection region on the screen SC. The swipe operation is operation for sliding (moving) a finger in a state in which the finger is set in contact with the display panel 303. The operation input section 304 determines coordinates (coordinates on the display panel 303) indicating a position of the display panel 303 on which a touch of a finger of the user is detected (hereinafter referred to as first position) and a position of the display panel 303 where the finger is detached from the display panel 303 (i.e., a position where the touch of the finger is detected last; hereinafter referred to as second position) and outputs specified coordinate data to the control section 310.

The control section 310 determines on the basis of an input from the operation input section 304 whether operation is received (step S18). When there is no input of data from the operation input section 304, the control section 310 determines that operation is not received (NO in step S18) and stays on standby until a signal is input from the operation input section 304. When data is input from the operation input section 304, the control section 310 determines that operation is received (YES in step S18) and determines on the basis of the input data whether the received operation is the swipe operation (step S19).

When the coordinate data of the first position and the second position is input from the operation input section 304, the control section 310 determines that the received operation is the swipe operation (YES in step S19). When the data input from the operation input section 304 is data other than the coordinate data indicating the first position and the second position, the control section 310 determines that the received operation is not the swipe operation (NO instep S19). Processing performed when the received operation is not the swipe operation (NO in step S19) is explained below.

When the received operation is the swipe operation (YES in step S19), the control section 310 determines, on the basis of the coordinate data of the first position and the second position input from the operation input section 304, a moving direction and a movement amount for moving the projection region. The control section 310 determines a direction from the coordinate of the first position to the coordinate of the second position as the moving direction of the projection region (step S20). The control section 310 calculates the distance between the first position and the second position and determines, on the basis of the calculated distance, the movement amount for moving the projection region (step S20). After determining the moving direction and the movement amount of the projection region, the control section 310 transmits data (operation data) indicating the determined moving direction and the determined movement amount to the projector 100 (step S21).

The control section 310 transmits the data indicating the moving direction and the movement amount to the projector 100 (step S21), returns to the determination in step S14, and stays on standby until data transmitted from the projector 100 is received.

The projector 100 determines whether the data transmitted from the terminal device 300 is received by the wireless communication section 137 (step T18). When the data is not received (NO instep T18), the control section 160 stays on standby until the data is received (step T18). When the data is received (YES in step T18), the control section 160 determines whether the received data is the data indicating the moving direction and the movement amount of the projection region (step T19).

When the received data is the data indicating the moving direction and the movement amount of the projection region (YES in step T19), the control section 160 generates, with the projection control section (the control section) 161, on the basis of the input data, control signal for controlling a rotating direction and a rotation amount of a stepping motor of the projection-optical-system driving section 123. The projection control section 161 outputs the generated control signal to the projection-optical-system driving section 123. The projection-optical-system driving section 123 drives the stepping motor according to the control signal input from the projection control section 161 and changes the lens position of the projection lens 114 (step T20). Consequently, the projected image projected on the screen SC moves in a direction corresponding to the swipe operation by a distance corresponding to the swipe operation.

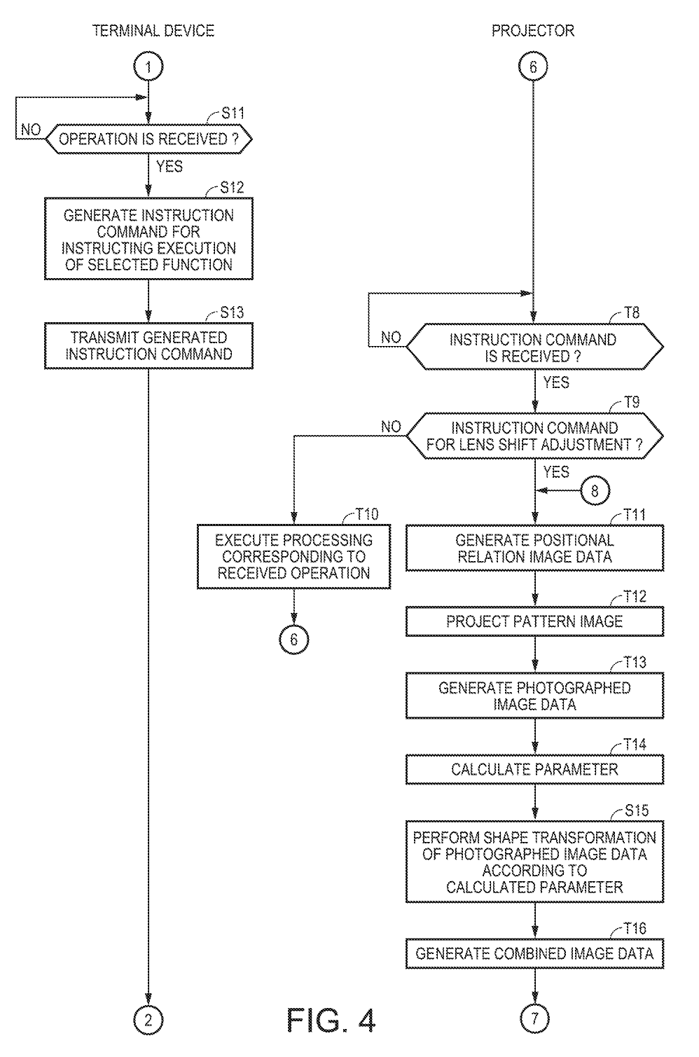

Thereafter, the control section 160 of the projector 100 returns to step T11 in FIG. 4 and performs the processing again from the generation of positional relation image data indicating a relative relation between the present projection region and the lens shiftable region.

In the terminal device 300, when determining in step S19 that the received operation is not the swipe operation (NO in step S19), the control section 310 determines whether the data input from the operation input section 304 is data indicating operation for ending the lens shift adjustment (step S22).

When the input data is not the data indicating the operation for ending the lens shift adjustment (NO in step S22), the control section 310 executes processing corresponding to operation indicated by the input data (step S23) and returns to the determination in step S18. When the input data is the data indicating the operation for ending the lens shift adjustment (YES in step S22), the control section 310 generates an end command for instructing the end of the lens shift adjustment and transmits, with the mobile communication section 301, the end command to the projector 100 (step S24).

When determining in step T19 that the received data is not the data indicating the moving direction and the movement amount of the projection region (NO in step T19), the control section 160 of the projector 100 determines whether the received data is the end command (step T21).

When the received data is not the end command (NO in step T21), the control section 160 performs processing corresponding to the received data (step T22), returns to the determination in step T18, and stays on standby until data transmitted from the terminal device 300 is received. When the received data is the end command (YES in step T21), the control section 160 ends the processing of the lens shift adjustment and, for example, processes an image signal supplied from the image supply device 200 and shifts to an image projection mode for projecting an image on the screen SC.

As explained above, in the image projection system 1 and the control method for the image projection system 1 according to the embodiment, the projector 100 includes the projection optical system 113, the combined-image generating section 164, the wireless communication section 137, and the projection control section 161.

The projection optical system 113 projects an image on the screen SC. The combined-image generating section 164 generates the combined image indicating the correspondence between the projected image projected by the projection optical system 113 and the region where the projected image is movable. The wireless communication section 137 transmits the combined image generated by the combined-image generating section 164 to the terminal device 300. The projection control section 161 controls the projection optical system 113 according to the operation indicated by the data transmitted by the terminal device 300 to move the projecting position of the projected image.

The terminal device 300 includes the display section 302 including the display panel 303, the operation input section 304 that receives operation on the display panel 303, and the control section 310. The control section 310 causes the display panel 303 to display the image transmitted by the projector 100 and, during the display of the image, transmits the data indicating the operation received by the operation input section 304 to the projector 100.

Therefore, in the terminal device 300, the user can perform operation while viewing the combined image transmitted from the projector 100. Therefore, it is possible to improve operability in operating, with the terminal device 300, a state of the projected image projected by the projector 100.

For example, in a configuration for photographing the screen SC with the terminal device 300, causing the terminal device 300 to display a photographed image, and performing operation, the user needs to hold the terminal device 300 to be able to appropriately photograph the screen SC. In the case of the lens shift adjustment, it is desirable to photograph a projected image in a fixed position and at a fixed angle to be able to recognize a change in a projecting position of the projected image. However, when the user holds the terminal device 300 by hand and photographs a projected image, it is difficult to perform the photographing in the fixed position and at the fixed angle.

On the other hand, in this embodiment, photographing is performed by the photographing section 140 mounted on the projector 100. Therefore, it is possible to photograph a projected image in the fixed position and at the fixed angle. Therefore, the combined-image generating section 164 can generate a combined image with which a change in a projecting position of the projected image can be recognized.

When operation of the user is received in the terminal device 300 and the projector 100 performs processing corresponding to data indicating the operation transmitted from the terminal device 300, a state of a projected image projected by the projector 100 changes. Therefore, the configuration in which the projected image is photographed by the terminal device 300, every time the user performs operation in the terminal device 300, the user needs to photograph the projected image by holding the terminal device 300 to be able to appropriately photograph the screen SC.

On the other hand, in this embodiment, the photographing section 140 mounted on the projector 100 photographs a projected image and transmits a combined image generated on the basis of the photographed image to the terminal device 300. Therefore, the user does not need to hold the terminal device 300 to be able to appropriately photograph the screen SC.

The projecting section 125 includes the projection lens 114 and the projection-optical-system driving section 123 that shifts the projection lens 114 and moves a projecting position of a projected image. The combined-image generating section 164 generates a combined image indicating a region where the projection-optical-system driving section 123 can move the projected image by shifting the projection lens 114. Therefore, it is possible to display, in the combined image, a region where a lens position of the projection lens 114 is movable according to lens shift adjustment.

The combined-image generating section 164 generates the projected image, the lens shiftable region, and a combined image indicating a positional relation between the projected image and the lens shiftable region. Therefore, it is possible to grasp the positional relation between the projected image and the lens shiftable region from the combined image displayed on the terminal device 300.

A pattern photographed image obtained by extracting a portion corresponding to the projected image from photographed image data is combined with the figure data 502 to generate the combined image. Therefore, it is possible to clearly indicate the portion corresponding to the projected image in the combined image.

The embodiment explained above indicates a preferred embodiment of the invention and does not limit the invention. Various modified implementations are possible within a range not departing from the spirit of the invention.

For example, in the embodiment, the change of the position of the projection region in the screen SC is performed by the swipe operation on the display panel 303 of the terminal device 300. However, a moving direction and a moving distance of the projection region may be designated by operation of the push button keys and the like.

In the embodiment, the control section 310 of the terminal device 300 executes the Web browser 306 and the projector 100 executes the Web server 171 for providing a Web page in response to a request of the Web browser 306 to perform the processing shown in the flowcharts of FIGS. 3 to 6. Besides, it is also possible to install a dedicated application program in the terminal device 300 and cause the control section 310 of the terminal device 300 to execute the application program and realize the processing of the terminal device 300. In this case, the terminal device 300 and the projector 100 can also be connected to be capable of performing data communication according to a short range wireless communication system such as a wireless LAN, Bluetooth, UWB, and infrared communication or a wireless communication system that makes use of a mobile communication line.

The terminal device 300 executes the application program and transmits data indicating operation received by the operation input section 304 to the projector 100. The projector 100 receives the data transmitted from the terminal device 300 and changes a lens position of the projection lens 114 according to the received data.

The functional sections of the projector 100 and the terminal device 300 shown in FIG. 2B indicate functional components realized by cooperation of hardware and software. A specific mounting form is not particularly limited. Therefore, hardware individually corresponding to the functional sections does not always need to be mounted. Naturally, it is also possible to adopt a configuration in which one processor executes a computer program to realize functions of a plurality of functional sections. Apart of the functions realized by software in the embodiment may be realized by hardware. A part of the functions realized by hardware may be realized by software.

What is claimed is:

1. An image projection system comprising:
a projector; and
a terminal device, wherein
the projector includes:
a projecting section configured to project an image;
a generating section configured to generate a correspondence image indicating correspondence between a projected image projected by the projecting section and a region where the projected image is movable; and
a transmitting section configured to transmit the correspondence image generated by the generating section to the terminal device,
the terminal device includes:
a display section including a display screen;
an operation section configured to receive operation on the display screen; and
a control section configured to cause the display screen to display the correspondence image transmitted by the projector and transmit, during the display of the correspondence image, operation data indicating operation received by the operation section to the projector, and
the projector includes a control section configured to control the projecting section according to the operation indicated by the operation data and move a projecting position of the projected image.

2. The image projection system according to claim 1, wherein
the projector includes a photographing section configured to photograph the projected image, and
the generating section generates the correspondence image on the basis of a photographed image of the photographing section.

3. The image projection system according to claim 1, wherein
the projecting section includes:
a projection lens; and
a lens shift mechanism configured to shift the projection lens and move the projecting position of the projected image, and
the generating section generates the correspondence image indicating a region where the lens shift mechanism can move the projected image by shifting the projection lens.

4. The image projection system according to claim 2, wherein
the projecting section projects an image on a projection target, and
the generating section generates the correspondence image including the projected image, the region where the projected image is movable, and figure data indicating a positional relation between the projected image and the region where the projected image is movable, an extracted image obtained by extracting a portion corresponding to the projected image from the photographed image being combined with the figure data.

5. A projector comprising:
a projecting section configured to project an image;
a generating section configured to generate a correspondence image indicating correspondence between a projected image projected by the projecting section and a region where the projected image is movable;
a transmitting section configured to transmit the correspondence image generated by the generating section to a terminal device; and
a control section configured to control the projecting section according to operation indicated by operation data transmitted by the terminal device to move a projecting position of the projected image.

6. A control method for an image projection system including a projector and a terminal device, the control method comprising:
generating, in the projector, a correspondence image indicating correspondence between a projected image projected by a projecting section that projects an image and a region where the projected image is movable;
transmitting, in the projector, the generated correspondence image to the terminal device;
causing, in the terminal device, a display screen to display the correspondence image transmitted by the projector;
receiving, in the terminal device, operation on the display screen in an operation section during the display of the correspondence image;
transmitting, in the terminal device, operation data indicating the received operation to the projector; and
moving, in the projector, a projecting position of the projected image according to the operation indicated by the operation data.
